(19) United States
(12) Patent Application Publication
(10) Pub. No.: US 2007/0200653 A1
(43) Pub. Date: Aug. 30, 2007

(54) ELECTROMAGNETIC ACTUATOR

(75) Inventors: Yasuhiro Matsumoto, Naka-Shi (JP); Yosuke Tonami, Asaka-Shi (JP); Yoshinobu Ishikawa, Tokyo (JP); Nobutaka Kubota, Tokyo (JP); Takeshi Noda, Tokyo (JP); Kazuhiro Matsuo, Tokyo (JP); Kenji Kato, Tokyo (JP); Mitsutaka Homma, Tokorozawa-Shi (JP); Takao Wakabayashi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/678,425

(22) Filed: Feb. 23, 2007

(30) Foreign Application Priority Data
Feb. 24, 2006 (JP) 2006-048587

(51) Int. Cl. H01H 9/00

(52) U.S. Cl. 335/179

(57) ABSTRACT

A needle 2 includes a plunger member 21 and a collar member 22, and is provided to be reciprocable from a latch position to a latch release position inside a stator 1. A first magnet coil 31 has sufficient electromagnetic power to put in a latch state the needle 2 which is in a latch release state on energization. A permanent magnet 4 has sufficient absorption power for absorbing a collar member 22 of the needle 2 put in the latch state by the electromagnetic power of the first magnet coil 31 and maintaining the latch state even when the first magnet coil 31 is in a non-energized state. A second magnet coil 32 can diminish magnetic fluxes of the permanent magnet 4 and change the needle 2 from the latch state to the latch release state on energization. Thus, energy efficiency is improved by varying how to energize the magnet coils according to the state of a load side.

### CROSS REFERENCE TO RELATED APPLICATIONS

This application claims benefit of priority under 35 USC § 119 to Japanese Patent Application No.2006-48587 filed on Feb. 24, 2006, the entire contents of which are incorporated by reference.

### BACKGROUND OF THE INVENTION

1. Field of the Invention

The present invention relates to an electromagnetic actuator which is used for various kinds of industrial equipment, such as a switching device and an industrial robot.

2. Related Art

The electromagnetic actuator is normally constituted by combining a magnet coil and a permanent magnet, where the magnet coil is energized to move a needle and then the magnet coil is non-energized to latch the needle at its moved position by absorption power of the permanent magnet.

FIG. 6 is an explanatory diagram of the electromagnetic actuator according to a first conventional example disclosed in Japanese Patent Laid-Open No. 7-37461 (1995) as patent document 1. In FIG. 6, a stator 101 includes a frame member 102, a ring-shaped permanent magnet 103 fixed on the frame member 102, a first magnet coil 104 and a second magnet coil 105 provided on both sides of the permanent magnet 103. A needle 106 includes a core 107 provided to be horizontally reciprocable inside the stator 101 and an axis 108 supported by the core 107.

In the shown state, a current larger than the current of the second magnet coil 105 is supplied to the first magnet coil 104, and so the number of magnetic fluxes 109 is larger than the number of magnetic fluxes 110. Therefore, the needle 106 is moved leftward by a leftward driving force. If the first magnet coil 104 and second magnet coil 105 are non-energized in this state, the needle 106 is latched at the shown position by the magnetic fluxes of the permanent magnet 103.

In the case of moving the needle 106 rightward, a current larger than the current of the first magnet coil 104 is supplied to the second magnet coil 105 so as to diminish the magnetic fluxes of the permanent magnet 103 and give a rightward driving force to the needle 106.

FIGS. 7A and 7B are explanatory diagrams of the electromagnetic actuator according to a second conventional example disclosed in Japanese Patent Laid-Open No. 2002-289430 as patent document 2. FIG. 7A is a longitudinal section showing a latch release state of the needle, and FIG. 7B is a longitudinal section showing the state of the needle just before latching.

A stator 201 includes a frame member 202, a ring-shaped permanent magnet 203 fixed on the frame member 202 and a magnet coil 204 provided below the permanent magnet 203. A needle 205 includes a plunger member 206 provided to be vertically reciprocable inside the stator 201, a collar member 207 mounted at a top edge of the plunger member 206 and an axis member 208 supported by the plunger member 206.

In the state of FIG. 7A, the collar member 207 is positioned much higher than the permanent magnet 203, and so a force exerted to the needle 205 by a magnetic flux Bm of the permanent magnet 203 is little. If the magnet coil 204 is energized in this state, however, a downward driving force F0 is generated by a magnetic flux Bc of the magnet coil 204 so that the needle 205 descends.

If the needle 205 descends as in the state of FIG. 7B, the magnetic flux Bm of the permanent magnet 203 passes through the entire length of the collar member 207 and the plunger member 206 to merge into the magnetic flux Bc. Therefore, the downward driving force to the needle 205 becomes very strong. If the magnet coil 204 is non-energized in this state, the downward driving force weakens because the magnetic flux Bc is eliminated. However, the needle 205 is latched at an as-is position by the magnetic flux Bm.

In the case of moving the needle 205 upward from a latch position of FIG. 7B, energization should be performed to reverse a direction of the current passing through the magnet coil 204 so as to diminish the magnetic fluxes of the permanent magnet 203 and give an upward driving force to the needle 205.

In both the above-mentioned first and second conventional examples, one magnet coil is used to perform two actions of diminishing the magnetic fluxes of the permanent magnet and giving the driving force to the needle in the case of moving the needle which is latched by the permanent magnet in an opposite direction. For that reason, the energization of the magnet coil is uniformly controlled so that the current passing through the coil becomes a certain level or higher.

Depending on the state of a load side, however, it is not always necessary to give a great driving force to the needle. It is possible to release the latch just by diminishing the magnetic fluxes of the permanent magnet and move the needle as-is in the opposite direction. Therefore, there is further room for improvement as to the above-mentioned conventional apparatuses from a perspective of effective utilization of energy.

### SUMMARY OF THE INVENTION

An object of the present invention is to provide an electromagnetic actuator which can improve energy efficiency by varying how to energize a magnet coil according to a state of a load side.

To attain the object, the present invention provides an electromagnetic actuator of a first configuration which includes: a needle having an approximately cylindrical plunger member and a collar member mounted at a base thereof (of the plunger member) and provided to be reciprocable between a latch position and a latch release position inside a stator; a first magnet coil provided surrounding the plunger member and having sufficient electromagnetic power to put in a latch state the needle in a latch release state on energization; a permanent magnet having sufficient absorption power for absorbing the collar member of the needle put in the latch state by the electromagnetic power of the first magnet coil and maintaining the latch state even when the first magnet coil is non-energized; and a second magnet coil capable of diminishing magnetic fluxes of the permanent magnet and changing the needle from the latch state to the latch release state on energization.

In a second configuration, the stator of the first configuration includes: a first stator having the first magnet coil mounted thereon and capable of forming a magnetic path of the magnetic fluxes generated by the first magnet coil; and a second stator having the permanent magnet and the second magnet coil mounted thereon and capable of forming a magnetic path of the magnetic fluxes generated by the permanent magnet and the second magnet coil.

In a third configuration, the first stator of the second configuration includes an absorbing portion on which an absorbing surface for absorbing a head of the plunger member in the latch state is formed; and the position of the absorbing surface is deviated by a distance L2 from a center position of axial length L1 of the first magnet coil in a direction to be apart from the needle.

In a fourth configuration, a ratio between the distance L2 and the axial length L1 of the third configuration (L2/L1) is 10 to 30%.

In a fifth configuration, a concave portion for concentrating the magnetic fluxes is formed on at least one of the absorbing surface of the absorbing portion of the first stator and a contact surface of the head of the plunger member contacting the absorbing surface in the third or fourth configuration.

In a sixth configuration, surface area of the concave portion in the fifth configuration is 30% or more of the absorbing surface or the contact surface.

In a seventh configuration, a diameter of the concave portion in the fifth configuration is 30% or more of an outside diameter of the absorbing portion or the head.

In an eighth configuration, depth h2 of the concave portion in one of the fifth to seventh configurations is 3 mm or less.

In a ninth configuration, thickness t1 of the collar member in one of the first to eighth configurations is smaller than radial width h1 of an absorbing action surface on which the permanent magnet exerts an absorbing action to the collar member.

In a tenth configuration, a lightening portion is formed inside the plunger member in one of the first to ninth configurations.

In an eleventh configuration, sectional area of the lightening portion in the tenth configuration is 30% or more of the sectional area of the plunger member.

In a twelfth configuration, the diameter of the lightening portion in the tenth configuration is 30% or more of the outside diameter of the plunger member.

According to the present invention, the magnet coils are divided into the first magnet coils for giving a driving force to the needle and the second magnet coils for diminishing the magnetic fluxes of the permanent magnet. Therefore, it is possible to select energization or non-energization of the two magnet coils as appropriate according to the state of the load side so as to improve the energy efficiency.

### BRIEF DESCRIPTION OF THE DRAWINGS

FIG. 1 is a longitudinal section showing a configuration in the case where a needle of an electromagnetic actuator according to an embodiment of the present invention is in a latch release state;

FIG. 2 is a longitudinal section showing the configuration in the case where the needle of the electromagnetic actuator according to the embodiment of the present invention is in a latch state;

FIG. 3 is an explanatory diagram showing a magnetic flux distribution state in the case of moving the needle of FIG. 1 upward;

FIG. 4 is an explanatory diagram showing the magnetic flux distribution state in the case of latching the needle of FIG. 2;

FIG. 5 is an explanatory diagram showing the magnetic flux distribution state in the case of moving the needle of FIG. 2 downward;

FIG. 6 is an explanatory diagram of the electromagnetic actuator according to a first conventional example; and

FIGS. 7A and 7B are explanatory diagrams of the electromagnetic actuator according to a second conventional example.

### DESCRIPTION OF PREFERRED EMBODIMENTS

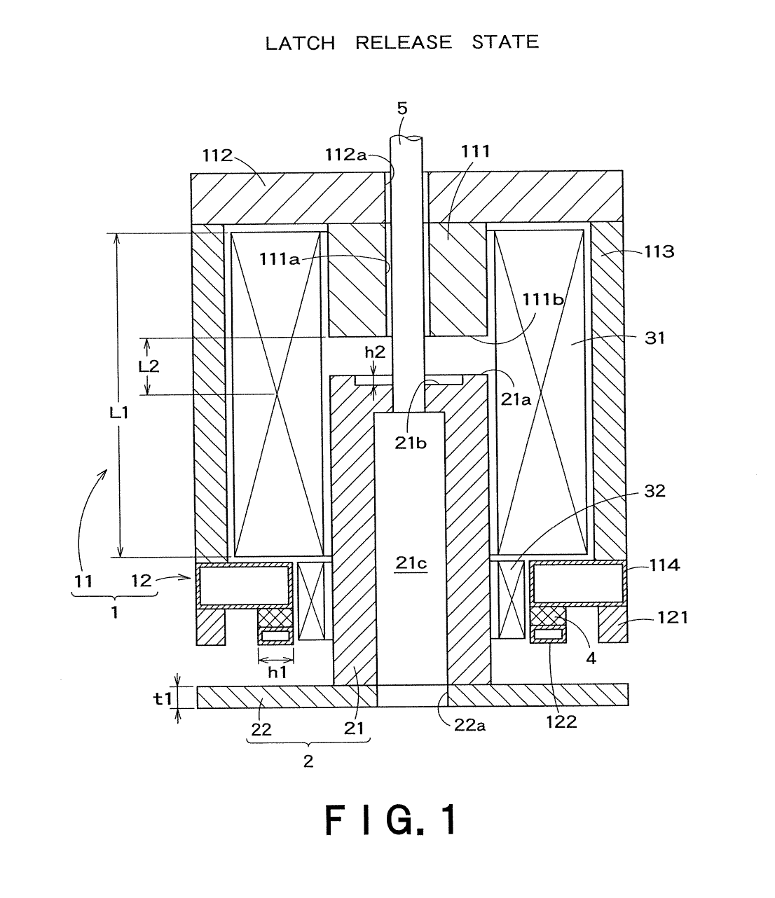

FIG. 1 is a longitudinal section showing a configuration of an electromagnetic actuator according to an embodiment of the present invention, which shows the case where a needle 2 is in a latch release state. In FIG. 1, a stator 1 includes a first stator 11 and a second stator 12.

The first stator 11 is composed of a pole piece 111 in a ring shape or a hollow cylinder shape with an opening 111a and an absorbing surface 111b formed thereon, a disk member 112 fixed on an upper end face of the pole piece 111 and having an opening 112a formed thereon, a cylinder member 113 fixed on a periphery side of a lower end face of the disk member 112, and a hollow member 114 fixed on the lower end face of the cylinder member 113. All the pole piece 111, disk member 112, cylinder member 113 and hollow member 114 are formed by a magnetic material.

The second stator 12 is composed of a cylinder member 121 fixed on the periphery side of the lower end face of the hollow member 114 and a hollow member 122 fixed on an inner periphery side of the lower end face of the hollow member 114 via a permanent magnet 4. The cylinder member 121 and hollow member 122 are also formed by the magnetic material. The permanent magnet 4 and the hollow member 122 are in a ring shape having the same radial width h1.

The needle 2 is composed of an approximately cylindrical plunger member 21 and a disk-shaped collar member 22, and an axis member 5 linked to the load side is mounted at a head center position of the plunger member 21. Thickness of the collar member 22 is t1, which is a value smaller than the radial width h1 of the permanent magnet 4. The plunger member 21 and the collar member 22 are also formed by the magnetic material.

A first magnet coil 31 is provided in a space formed between periphery surfaces of the pole piece 111 and plunger member 21 and an inner periphery surface of the cylinder member 113. A second magnet coil 32 is provided in a space at a position below the first magnet coil 31 and formed between the periphery surface of the plunger member 21 and the inner periphery surfaces of the hollow member 114, permanent magnet 4 and hollow member 122.

The first magnet coil 31 is primarily intended to give a driving force to the needle 2, and its current-carrying capacity is large. The second magnet coil 32 is primarily intended to diminish the magnetic fluxes of the permanent magnet 4 which are latching the needle 2 although it may also contributes to giving the driving force to the needle 2 in conjunction with the first magnet coil 31. Therefore, the current-carrying capacity of the second magnet coil 32 is smaller than that of the first magnet coil 31.

The upper end face of the head of the plunger member 21 opposed to the absorbing surface 111b of the pole piece 111 is a contact surface 21a, and a concave portion 21b of depth h2 is formed to be predetermined area on the contact surface 21a. To be more specific, absorption power “F” of the magnet is proportional to a square of magnetic flux density “B” as shown in a formula (1) below.
F=Bˆ2*A/μ0 (1)

In the formula (1), μ0 denotes space permeability and A denotes magnetic flux passage area. It is possible, by forming the concave portion 21b at the head of the plunger member 21, to concentrate the magnetic fluxes about to pass all over the head in the concave portion 21bTherefore, it is possible to increase the magnetic flux density “B” and intensify the absorption power “F.”

A lightening portion 21c is formed inside the plunger member 21, and an opening 22a is formed on the collar member 22 to continue from the lightening portion 21c. The lightening portion 21c and opening 22a are formed so as to render the needle 2 lightweight and allow many magnetic fluxes to pass through to the center of the needle 2 in a short time. In reality, operating time for the needle 2 to be in the latch state from the latch release state is approximately 0.2 seconds. In the case where the lightening portion 21c is not formed, operation is completed before the magnetic fluxes permeate around the center of the needle 2.

The first magnet coil 31 has axial length L1. And the absorbing surface 111b of the aforementioned pole piece 111 is formed at a position deviated by a distance L2 from the center position of the axial length L1 in a direction to be apart from the needle 2. According to this embodiment, a ratio between the distance L2 and the axial length L1 (L2/L1) is a predetermined value described later.

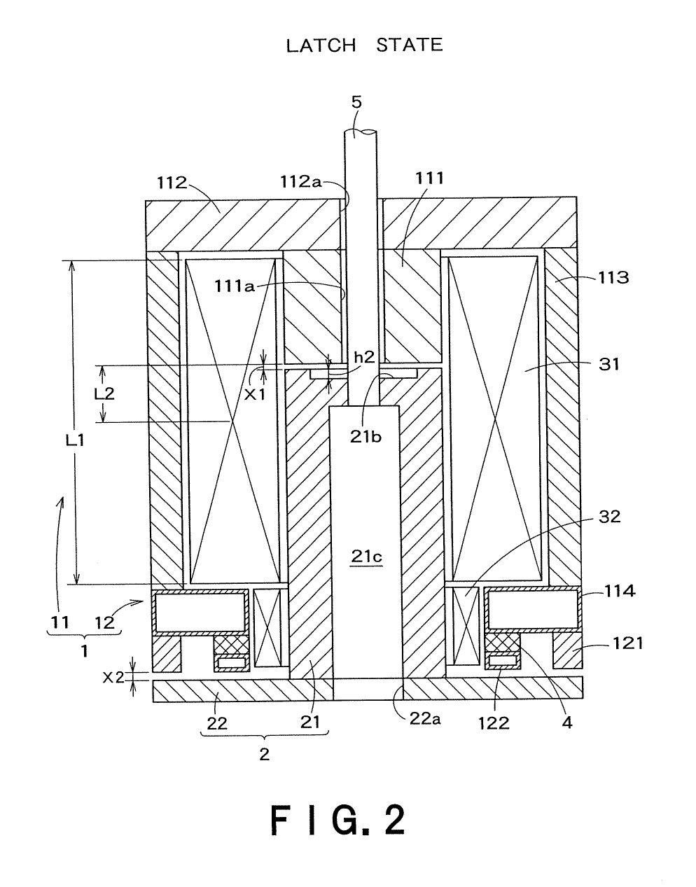

FIG. 2 shows the state where the needle 2 is pulled upward and latched from the state of FIG. 1. In this state, a clearance X1 is formed between the absorbing surface 111b and the contact surface 21a, and a clearance X2 is formed between undersides of the cylinder member 121 and hollow member 122 and a top surface of the collar member 22. The values of the clearances X1 and X2 are 0 or a minimum value.

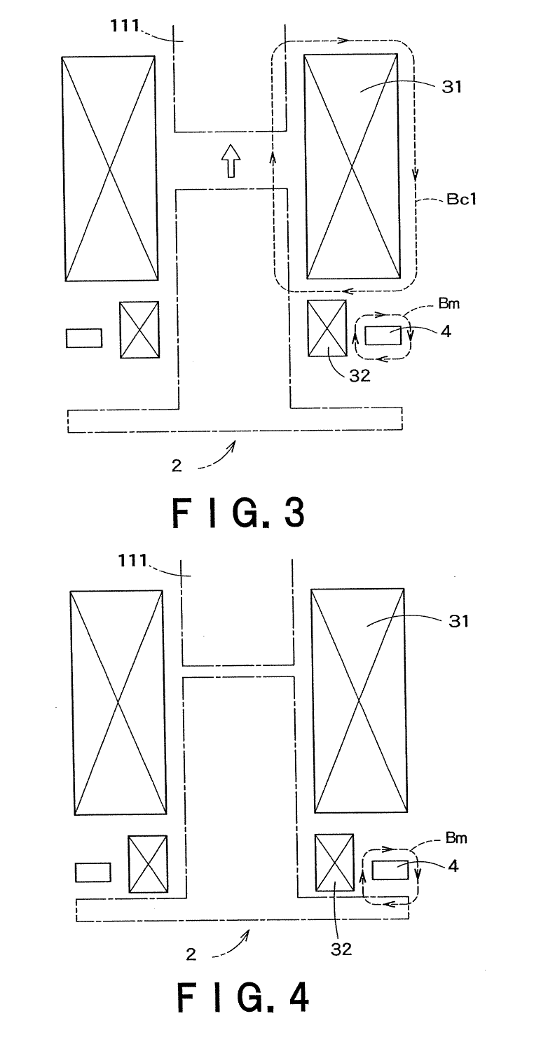

Next, a description will be given as to the operation of this embodiment configured as above. FIGS. 3 to 5 are explanatory diagrams schematically showing the respective magnetic flux distribution states of the first magnet coil 31, second magnet coil 32 and permanent magnet 4 in the case of moving the needle 2.

As shown in FIG. 3, the first magnet coil 31 is energized in the case of moving the needle 2 in the latch release state upward. And then, a magnetic flux Bc1 is generated around the first magnet coil 31, and a part thereof pass through the needle 2 so that an upward driving force is generated against the needle 2. For this reason, the needle 2 moves upward.

Next, when the needle 2 moves to the position shown in FIG. 4, energization of the first magnet coil 31 is stopped to put it in a non-energized state. However, a part of a magnetic flux Bm of the permanent magnet 4 passes through the collar member 22 of the needle 2 at this position so that electromagnetic power of the magnetic flux Bm latches the needle 2.

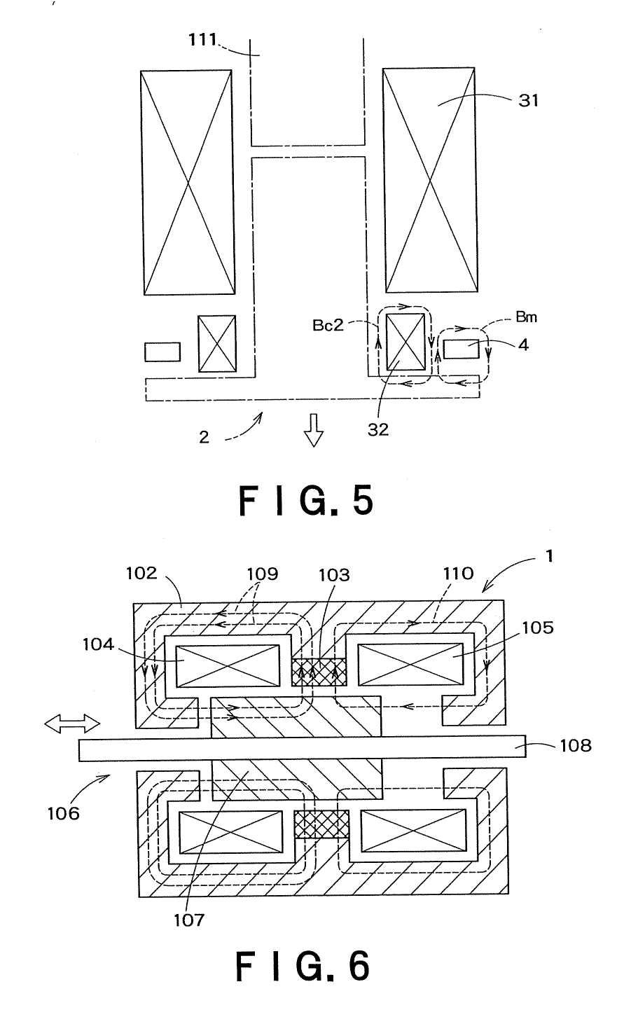

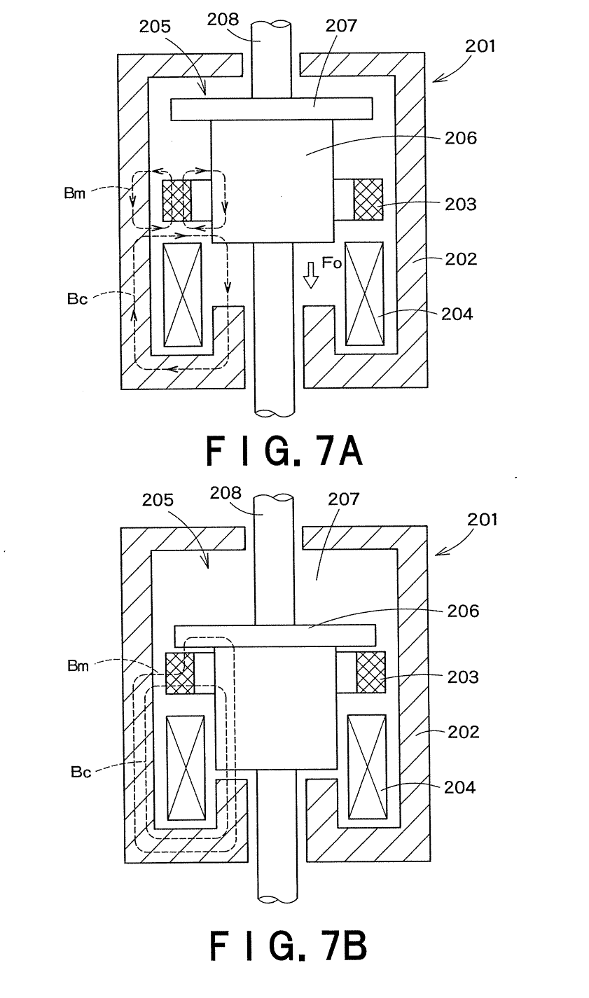

In the case of moving downward the needle 2 in the latch state as above, only the second magnet coil 32 is energized to diminish the magnetic flux Bm of the permanent magnet 4 by means of a magnetic flux Bc2 thereof as shown in FIG. 5. Thus, holding power of the permanent magnet 4 weakens against the collar member 22, and the needle 2 moves downward.

A conventional apparatus performed the energization for moving the needle 2 upward and the energization for releasing the latch of the needle 2 by using one magnet coil having large current-carrying capacity. As for the configuration of FIG. 1, however, only the first magnet coil 31 is energized in the case of moving the needle 2 upward while only the second magnet coil 32 is energized in the case of releasing the latch of the needle 2. It is thereby possible to improve efficiency by keeping energy consumption to the minimum necessary.

However, the above operation of energization is just an example. In reality, it is possible, by considering conditions of the load side and other conditions, to select a combination of energization and non-energization for the two magnet coils as appropriate so as to precisely control the electromagnetic actuator according to circumstances.

In the state of FIG. 3 for instance, only the first magnet coil 31 is energized to move the needle 2 upward. In the case where resistance on the load side is high for instance, the upward driving force can be increased by energizing the second magnet coil 32 as well. In the state of FIG. 5, it is possible to not only diminish the magnetic flux Bm of the permanent magnet 4 but also supply the downward driving force to the needle 2 by energizing the first magnet coil 31 instead of the second magnet coil 32 or by energizing both the second magnet coil 32 and first magnet coil 31.

To realize the electromagnetic actuator of high efficiency, the inventors hereof performed trials and experiments by variously changing the values of various parameters indicated by symbols in FIG. 1. A description will be given as to desirable data obtained as a result thereof. Of the following items (1) to (6), it turned out that the most effective item for increasing the absorption power against the needle 2 is (1).

(1) When the ratio between the axial length L1 of the first magnet coil 31 and the distance L2 from the coil center position to the absorbing surface 111b thereof (L2/L1) was in the range of 10 to 30%, the direction of the magnetic flux was apt to become parallel with the axial direction so that great electromagnetic power (absorption power) could be obtained.

(2) It is desirable that surface area of the concave portion 21b at the head of the plunger member 21 be 30 to 90% of the entire area of the absorbing surface 111b (or the contact surface 21a). In the case of 30% or more, the magnetic flux density at the end of the concave portion 21b increases so that great absorption power can be obtained. In the case of 90% or more, however, the end of the concave portion 21b becomes magnetically saturated and so the absorption power is reduced on the contrary. In reality, a numeric value close to 90% should be adopted because it is desirable to have the absorption power to the extent of causing magnetic saturation. The same result can be obtained by rendering the diameter of the concave portion 21b 30 to 90% of an outside diameter of the absorbing surface 111b (or the outside diameter of the head).

(3) It is desirable that the depth h2 of the concave portion 21b be in the range of 0.5 to 3 mm. It is because working on the concave portion 21b becomes easier by rendering it 0.5 mm or more. If it exceeds 3 mm, it is not desirable because magnetic reluctance of the concave portion 21b increases and the absorption power obtained by the entire needle 2 is reduced.

(4) In the configuration of FIG. 1, the concave portion 21b is formed on the plunger member 21. Such a concave portion may also be formed on the absorbing surface 111b side of the pole piece 111. It is also possible to form such a concave portion on both the plunger member 21 and pole piece 111.

(5) It is desirable that sectional area of the lightening portion 21c be 30 to 50% of the sectional area of the plunger member 21. It is because, while a weight saving effect of the needle 2 is weak in the case of less than 30%, the effect of increasing the magnetic flux density can be obtained in addition to the weight saving effect in the case of 30% or more. If it exceeds 50%, there is a danger that the needle 2 may become magnetically saturated. The same result can also be obtained by setting the diameter of the lightening portion 21c at 30 to 50% of the outside diameter of the plunger member 21.

(6) It is desirable that thickness t1 of the collar member 22 be smaller than the radial width h1 of an absorbing action surface on which the permanent magnet 4 exerts an absorbing action on the collar member 22. It is because the magnetic flux density can thereby be increased.

1. An electromagnetic actuator comprising:
a needle having an approximately cylindrical plunger member and a collar member mounted at a base of the plunger member and provided to be reciprocable between a latch position and a latch release position inside a stator;
a first magnet coil provided surrounding the plunger member and having sufficient electromagnetic power to put in a latch state the needle in a latch release state on energization;
a permanent magnet having sufficient absorption power for absorbing the collar member of the needle put in the latch state by the electromagnetic power of the first magnet coil and maintaining the latch state even when the first magnet coil is non-energized; and
a second magnet coil capable of diminishing magnetic fluxes of the permanent magnet and changing the needle from the latch state to the latch release state on energization.

2. The electromagnetic actuator according to claim 1, wherein the stator includes:
a first stator having the first magnet coil mounted thereon and capable of forming a magnetic path of the magnetic fluxes generated by the first magnet coil; and
a second stator having the permanent magnet and the second magnet coil mounted thereon and capable of forming a magnetic path of the magnetic fluxes generated by the permanent magnet and the second magnet coil.

3. The electromagnetic actuator according to claim 2, wherein:
the first stator includes an absorbing portion on which an absorbing surface for absorbing a head of the plunger member in the latch state is formed; and
a position of the absorbing surface is deviated by a distance L2 from a center position of axial length L1 of the first magnet coil in a direction to be apart from the needle.

4. The electromagnetic actuator according to claim 3, wherein:
a ratio between the distance L2 and the axial length L1 (L2/L1) is 10 to 30%.

5. The electromagnetic actuator according to claim 4, wherein:
a concave portion for concentrating the magnetic fluxes is formed on at least one of the absorbing surface of the absorbing portion of the first stator and a contact surface of the head of the plunger member contacting the absorbing surface.

6. The electromagnetic actuator according to claim 5, wherein:
surface area of the concave portion is 30% or more of the absorbing surface or the contact surface.

7. The electromagnetic actuator according to claim 6, wherein:
a diameter of the concave portion is 30% or more of an outside diameter of the absorbing portion or the head.

8. The electromagnetic actuator according to claim 7, wherein:
depth h2 of the concave portion is 3 mm or less.

9. The electromagnetic actuator according to claim 8, wherein:
thickness t1 of the collar member is smaller than radial width h1 of an absorbing action surface on which the permanent magnet exerts an absorbing action to the collar member.

10. The electromagnetic actuator according to claim 9, wherein:
a lightening portion is formed inside the plunger member.

11. The electromagnetic actuator according to claim 10, wherein:
sectional area of the lightening portion is 30% or more of the sectional area of the plunger member.

12. The electromagnetic actuator according to claim 10, wherein:
the diameter of the lightening portion is 30% or more of the outside diameter of the plunger member.

13. The electromagnetic actuator according to claim 3, wherein:
a concave portion for concentrating the magnetic fluxes is formed on at least one of the absorbing surface of the absorbing portion of the first stator and a contact surface of the head of the plunger member contacting the absorbing surface.

14. The electromagnetic actuator according to claim 13, wherein:
surface area of the concave portion is 30% or more of the absorbing surface or the contact surface.

15. The electromagnetic actuator according to claim 14, wherein:
a diameter of the concave portion is 30% or more of an outside diameter of the absorbing portion or the head.

16. The electromagnetic actuator according to claim 15, wherein:
depth h2 of the concave portion is 3 mm or less.

17. The electromagnetic actuator according to claim 1, wherein:
thickness t1 of the collar member is smaller than radial width h1 of an absorbing action surface on which the permanent magnet exerts an absorbing action to the collar member.

18. The electromagnetic actuator according to claim 17, wherein:
a lightening portion is formed inside the plunger member.

19. The electromagnetic actuator according to claim 18, wherein:
sectional area of the lightening portion is 30% or more of the sectional area of the plunger member.

20. The electromagnetic actuator according to claim 18, wherein:
the diameter of the lightening portion is 30% or more of the outside diameter of the plunger member.
